(19) United States
(12) Patent Application Publication
(10) Pub. No.: US 2012/0302304 A1
(43) Pub. Date: Nov. 29, 2012

(54) WORD FLIP GAME AND APP FOR SMART PHONE AND COMPUTER

(75) Inventor: Robert Craig Steir, New York, NY (US)

(73) Assignee: MINDFORCE CONSULTING, LLC, New York, NY (US)

(21) Appl. No.: 13/478,862

(22) Filed: May 23, 2012

Related U.S. Application Data
(60) Provisional application No. 61/519,417, filed on May 23, 2011.

(51) Int. Cl. A63F 13/00

(52) U.S. Cl. 463/9

(57) ABSTRACT

A word game played individually, and with competitions against one or more other players, or in mass-person competitions, primarily played on a computer, smart phone or digital tablet. The game features a set number of block-sized “game pieces” consisting of any modern country's alphanumeric character set that are displayed as one long horizontal string of game pieces at the start of the game in a certain scrambled tile order (“Starting Order”) and need to be “repositioned” into a specific tile order (“Final Order”) in a series of moves called Tile Directional Flips (“TDFs”). Each tile represents a letter, number, or character of a country's alphanumeric characters or an image, color, symbol or mathematical symbol used. A blank space may also be a tile used in the game.

### CROSS-REFERENCE TO RELATED APPLICATIONS

This application claims the benefit of the following provisional application, which is hereby incorporated by reference herein in its entirety: U.S. Provisional Patent Application Ser. No. 61/519,417 filed May 23, 2011.

### BACKGROUND OF THE INVENTION

1. Field

The methods and systems described herein relate to novel and fun game piece rearranging games including word, number, image, color, or symbol games that can be played electronically on computers, tablets, mobile phones, and alternatively with physical game pieces. Word games have long been popular with people of all ages. Known word games include the game of “SCRABBLE”, in which blocks imprinted with the game pieces of the alphabet are selectively positioned end-to-end on a game board or table to spell words, and BOGGLE, in which blocks imprinted with the game pieces of the alphabet are selectively positioned in a grid (same rows and columns) where the player creates words based on game pieces that touch each other in at least one side.

2. Description of the Related Art

This section is intended to introduce the reader to various aspects of art which may be related to various aspects of the present invention which are described and/or claimed below. This discussion is believed to be helpful in providing the reader with background information to facilitate a better understanding of the various aspects of the present invention. Accordingly, it should be understood that these statements are to be read in this light, and not as admissions of prior art.

Since the proliferation of electronic entertainment devices and mobile communication devices, word games have also seen increased accessibility and creativity. Computer processors have turned the rearrangement of letters and other game elements from a tedious exercise to a simple function. The methods and systems described herein address new games related to the rearrangement of game pieces that may include letters, to achieve a desired outcome.

### SUMMARY OF THE INVENTION

The methods and systems described herein may comprise any of the following word/symbol/number/color ordering games.

In a game piece tile directional flip game using individual game pieces embodiment, the methods and systems disclosed herein may include a method for a word game. The methods may include first providing a plurality of electronic game pieces. The methods disclosed may also include providing an arrangement of the plurality of game pieces and identifying the relative position of two or more electronic game pieces within the arrangement. The methods disclosed can also include switching the relative positions of two or more electronic game pieces within the arrangement in response to a user action as a step of play. An electronic game piece can be a representation of an alphanumeric character. An electronic game piece can also be a representation of an image. An electronic game piece can be a representation of a color. An electronic game piece can also be a representative of a symbol. An electronic game piece can also be a representation of a mathematical symbol. An electronic game piece can be displayed electronically. An electronic game piece can be displayed using a graphical user interface. Electronically displayed electronic game pieces can also be displayed using an electronic advertisement. Two or more game pieces identified by the methods and systems disclosed can each be adjacent to at least one other game piece.

In a tile directional flip using clusters game embodiment, the methods and systems disclosed herein may include a method for a word game. The methods may include providing a plurality of electronic game pieces. The methods may further include providing a sequenced arrangement of the plurality of electronic game pieces and in response to a user action as a step in game play, reversing the sequence of the electronic game pieces. The methods can also include electronic game pieces that represent an alphanumeric character. An electronic game piece can also be a representation of an image. An electronic game piece can be a representation of a color. An electronic game piece can also be a representative of a symbol. An electronic game piece can also be a representation of a mathematical symbol. An electronic game piece can be displayed electronically. An electronic game piece can be displayed using a graphical user interface. Electronically displayed electronic game pieces can also be displayed using an electronic advertisement. The methods can also include a sequenced arrangement that includes a sequence of adjacent game pieces. The methods can further include a sequenced arrangement where the sequence of adjacent game pieces includes a first electronic game piece, a second electronic game piece and all game pieces with relative positions between the relative position of the first and second electronic game pieces.

In a tile directional flip on game embodiment, the methods and systems disclosed herein may include a method for a word game. The methods include providing a plurality of electronic game pieces. The methods further include providing a first sequenced arrangement of the plurality of electronic game pieces. The methods also include identifying a target sequenced arrangement of the electronic game pieces. The methods can include enabling a player, as a step in play, to reverse the sequence of any subset of electronic game pieces within the sequenced arrangement to provide a rearranged sequence of electronic game pieces. The methods then includes prompting the user to repeat a number of the sequence-reversing steps until the electronic game pieces match the target sequenced arrangement. An electronic game piece can be a representation of an alphanumeric character. An electronic game piece can also be a representation of an image. An electronic game piece can be displayed electronically. An electronic game piece can be displayed using a graphical user interface. Electronically displayed electronic game pieces can also be displayed using an electronic advertisement. The methods can also include a target sequenced arrangement that forms a series of words. The methods can also include a target sequenced arrangement that forms a series of alphanumeric characters. The methods can also include a target sequenced arrangement that forms a series of images. The methods can also include a target sequenced arrangement that forms a series of colors. The methods can also include a target sequenced arrangement that forms a series of symbols. The methods can also include a target sequenced arrangement that forms a series of mathematical symbols. The methods can additionally include a player identifying a target sequenced arrangement. The methods can also include a sequenced arrangement which include adjacent game pieces. The methods can additionally include a sequenced arrangement where the sequence of adjacent game pieces include a first electronic game piece, a second electronic game piece, and all game pieces with relative positions between the relative positions of the first and second electronic game pieces. The methods can additionally include a step in play wherein a player identifies a plurality of target sequenced arrangements. The methods also can include a new target sequenced arrangement that is different from any previous target sequenced arrangements.

In a tile directional flip on game with words embodiment, the methods and systems disclosed herein include a method for a word game. The invention includes providing a plurality of electronic game pieces. The methods can further include providing a first sequenced arrangement of the plurality of electronic game pieces. The methods can also include identifying a target sequenced arrangement of the electronic game pieces. The methods can also include enabling a player, as a step in play, the ability to reverse the sequence of any subset of electronic game pieces within the sequenced arrangement to provide a rearranged sequence of electronic game pieces. The methods can then include identifying a new target sequenced arrangement of the electronic game pieces. An electronic game piece can be a representation of an alphanumeric character. An electronic game piece can also be a representation of an image. An electronic game piece can be a representation of a color. An electronic game piece can also be a representative of a symbol. An electronic game piece can also be a representation of a mathematical symbol. An electronic game piece can be displayed electronically. An electronic game piece can be displayed using a graphical user interface. Electronically displayed electronic game pieces can also be displayed using an electronic advertisement. The methods can also include a target sequenced arrangement that forms a series of words. These series of words can also be an advertising slogan. The target sequenced arrangement can be form a series of alphanumeric characters or form a series of images, colors, symbols or mathematical symbols. The methods can also include a player identifying a target sequenced arrangement. The player can also identify a plurality of target sequenced arrangements. The methods can also include prompting the user to repeat a plurality of sequence-reversing steps and further identify a plurality of the target sequenced arrangements generated thereof. The methods can also include a sequenced arrangement of a series of adjacent game pieces. The sequence of adjacent game pieces can include a first electronic game piece, a second electronic game piece, and all game pieces with relative positions between the first and second game pieces. The method can include a new target sequenced arrangement that is different from the original target sequenced arrangement. The method can also further include a player further identifying a plurality of additional target sequenced arrangements within the original target sequenced arrangement or the new target sequenced arrangements. The method disclosed can provide new target sequenced arrangements that are different from previous target sequenced arrangements. The method can further include an identification of a target sequenced arrangement that advances a player's progression in a game. The method can also include identifying a final target sequenced arrangement, ending the game when a new target sequenced arrangement matches the final target sequenced arrangement.

In another embodiment, the methods and systems disclosed herein include a method for a word game. The invention includes providing a plurality of game pieces. The methods can further include providing a first sequenced arrangement of the plurality of game pieces. The methods can also include identifying a target sequenced arrangement of the game pieces. The methods can also include enabling a player, as a step in play, the ability to reverse the sequence of any subset of game pieces within the sequenced arrangement to provide a rearranged sequence of game pieces. The methods can then include identifying a new target sequenced arrangement of the game pieces. A game piece can be a representation of an alphanumeric character. A game piece can also be a representation of an image. A game piece can be a representation of a color. A game piece can also be a representative of a symbol. A piece can also be a representation of a mathematical symbol. A game piece can be displayed electronically. A game piece can be displayed using a graphical user interface. The methods can also include a target sequenced arrangement that forms a series of words. These series of words can also be an advertising slogan. The target sequenced arrangement can be form a series of alphanumeric characters or form a series of images, colors, symbols, or mathematical symbols. The methods can also include a player identifying a target sequenced arrangement. The player can also identify a plurality of target sequenced arrangements. The methods can also include prompting the user to repeat a plurality of sequence-reversing steps and further identify a plurality of the target sequenced arrangements generated thereof. The methods can also include a sequenced arrangement of a sequence of adjacent game pieces. The sequence of adjacent game pieces can include a first game piece, a second game piece, and all game pieces with relative positions between the first and second game pieces. The method can include a new target sequenced arrangement that is different from the original target sequenced arrangement. The method can also further include a player further identifying a plurality of additional target sequenced arrangements within the original target sequenced arrangement or the new target sequenced arrangements. The method disclosed could provide new target sequenced arrangements that are different from previous target sequenced arrangements. The method can further include an identification of a target sequenced arrangement that advances a player's progression in a game. The method can also include identifying a final target sequenced arrangement, ending the game when a new target sequenced arrangement matches the final target sequenced arrangement.

These and other systems, methods, objects, features, and advantages of the present invention will be apparent to those skilled in the art from the following detailed description of the preferred embodiment and the drawings. All documents mentioned herein are hereby incorporated in their entirety by reference.

### BRIEF DESCRIPTION OF THE FIGURES

The invention and the following detailed description of certain embodiments thereof may be understood by reference to the following figures:

FIG. 1 depicts the top view of a typical random listing of a sequenced arrangement of game pieces, at any step of play, where the top arrangement can be viewed as the initial Starting Order 102 of a new step of play, and the bottom arrangement designated as the Final Order 104, the final target sequenced arrangement that completes the game for the player.

FIG. 2 is the top view of the three stages of a TDF, the sequenced arrangement of electronic game pieces 202 where the player identifies a targeted subset of the sequenced arrangement 204 enabling a player, as a step in play, to reverse the targeted subset sequence of electronic game pieces 208 within the entire sequenced arrangement to provide a rearranged sequence of electronic game pieces, the Ending Order 210

FIG. 3 depicts the top view of 3 examples of a targeted subset of a sequenced arrangement (Cluster) of adjacent game pieces comprised of a first electronic game piece, a second electronic game piece, and all game pieces with relative positions between the relative position of the first electronic game piece and the relative position of the second electronic game piece

FIG. 4 is the top view of the rearranged game pieces after a TDF, the Ending Order 210. In this sequenced arrangement, each game piece is compared to its Final Order position. If a game piece is in its Final Order place, it is clearly marked, at this step of play, as being it its Ordered Place 212

FIG. 5 shows words formed during a Word Creation phase, after Stage 3 of the TDF when a player has the opportunity to form words if game includes ability to form words.

FIG. 6. is a representative game played from initial Starting Order 102 to Final Order 104, by showcasing the TDFs, the multiple sequence-reversing steps 202, 204, 208, 210 by the player until the game pieces match the Final Order's targeted sequenced arrangement 104

FIG. 7. shows two examples of the number of game pieces that can be used to form a target sequenced arrangement used for a game play. Example A 702 includes the alphabet's 26 game pieces (A-Z) as the initial Starting Order without any duplicates, and Example B 704 only includes 5 letters

FIG. 8. shows a Starting Order with a set number of game pieces as the initial Starting Order, and these same game pieces used, including blank spaces, to combine into words formed for an advertising slogan as the Final Order

FIG. 9 depicts examples of initial Starting Orders and Final Orders for electronic game pieces where these sequence arrangements form to represent 1) mathematical symbols and numbers 902, 2) images 904, 3) colors 906 and 4) symbols 908

FIG. 10 illustrates an initial Starting Order and a Final Order where the player uses all game pieces, where only 3 game pieces need to be in their Ordered Places 1002 at the completion of the Final Order

FIG. 11 illustrates an initial Starting Order and a Final Order where the player uses all game pieces, where only the 5 vowels (A, E, I, O, U) 1102 need to be in their Ordered Places at the completion of the Final Order

FIG. 12 illustrates an initial Starting Order and a Final Order where the player uses all game pieces, but only the displayed number of game pieces 1202 need to be in their Ordered Places at the completion of the Final Order

FIG. 13 illustrates an initial Starting Order and a Final Order where the player uses all game pieces, but only 5 Tiles 1302 need to be in any of the Ordered Places at the completion of the Final Order

FIG. 14 illustrates an initial Starting Order and a Final Order where the player uses all game pieces, and certain game pieces 1402, 1404, 1406 in certain Ordered Places for a particular Round need to be achieved (after the TDF has occurred) in order for the player to proceed with attaining the completion of the Final Order

FIG. 15 illustrates another example of an initial Starting Order and a Final Order where the player uses all game pieces, and certain game pieces 1502 in certain Ordered Places for a particular Round need to be achieved (after the TDF has occurred) in order for the player to proceed with attaining the completion of the Final Order,

FIG. 16 illustrates a game where the Final Order requires only one game piece 1602 to be in its Ordered Place in this FOGWW-only game

FIG. 17 depicts an initial Starting Order of a sequenced arrangement of game pieces, and a Final Order 1702 where the player does not have to use all these game pieces, and has to correctly match a defined series of game pieces, as the Final Order. In this game version, the Final Order does not have to include all the game pieces of the Starting Order, nor have definite Ordered Places to match at completion of the Final Order

FIG. 18 illustrates an initial Starting Order of a sequenced arrangement of game pieces, and a Final Order, where the player does not have to use all game pieces, but has to complete one or more phases 1802, a new target sequence arrangement of game pieces, before continuing to either the next phase, or to complete the Final Order, based on the rules of the game. In this game there is no need to create a Final Order configuration with all the game pieces, and only the need to match the Final Order's target sequenced arrangement 1804

FIG. 19 depicts a game play where certain game pieces do not move from their Ordered Place, and when a TDF occurs, the game pieces to be rearranged ignore the immobile game pieces

FIG. 20 illustrates creating words, from game pieces created from the display on multiple rows of previous target sequenced arrangements generated from TDFs where words can be formed across these multiple TDF rows and where game pieces need to be adjacent either up/down or diagonal as shown in these two word examples 2002, 2004

### DETAILED DESCRIPTION OF THE PREFERRED EMBODIMENT(S)

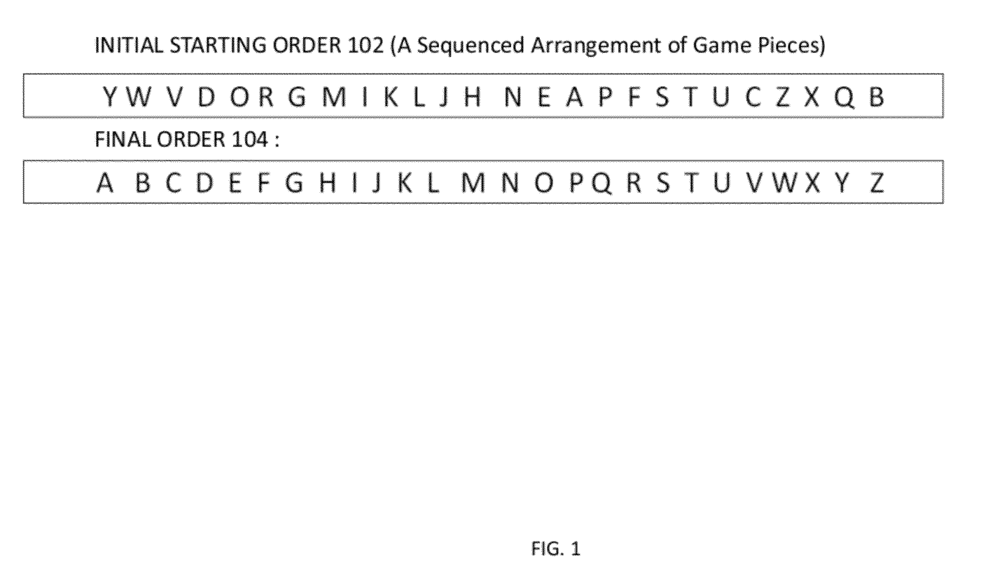

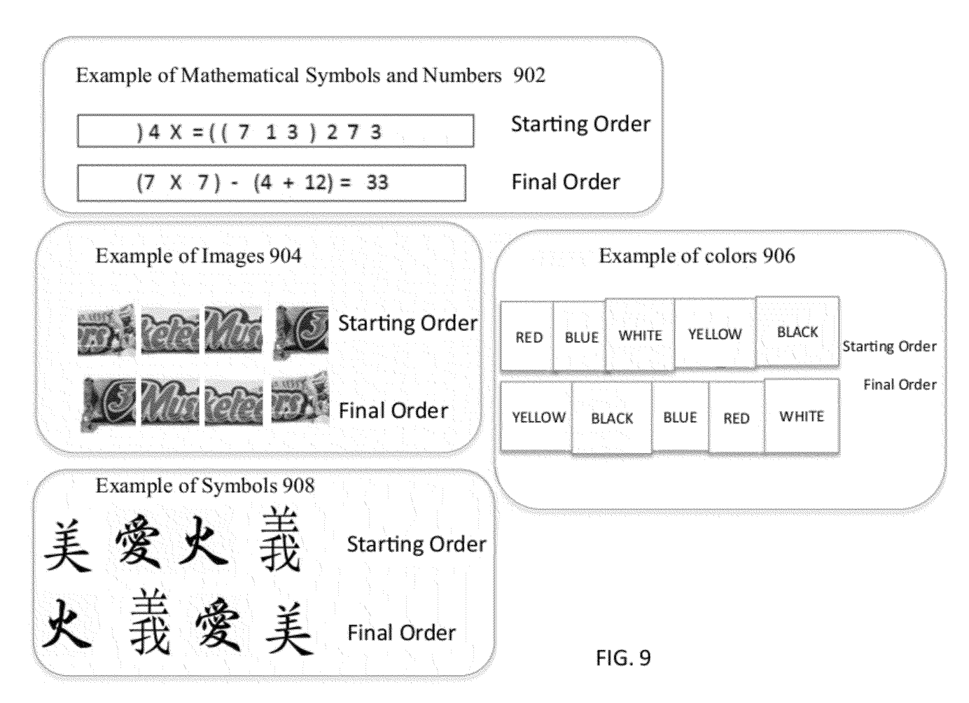

A word game that may be played individually, in competitions against one or more other players, or in mass-player competitions that may primarily be played electronically on a computer, smart phone or digital tablet, and may alternatively be played with physical game pieces. Such a word game may feature a set of block-sized electronic game pieces, also known as “Tiles” that may depict any modern country's alphanumeric character set, or, as depicted in FIG. 9, may depict images 904, colors 906, symbols 908, or mathematical symbols 902. Each tile may represent one letter, number, or character of a country's alphanumeric characters, or one image, color, symbol or mathematical symbol. A blank tile may also be used in the game. Referring to FIG. 1, which depicts an embodiment in which tiles, in a sequenced arrangement, in an initial starting order 102 are manipulated into a final order 104 using certain manipulation techniques. The game of FIG. 1 is played in one or more play rounds (herein Rounds). The player's objective is to manipulate or “rearrange” the arrangement of game pieces, building upon the results of each Round's manipulation, until a specific tile order arrangement “Final Order” 104, the target sequenced arrangement that completes the game for the player, is reached. Each Round consists of identifying the sequenced arrangement of game pieces, known as the “Starting Order” 202 and then executing a step in play called a Tile Directional Flip (“TDF”) where a subset of tiles are identified within the sequenced arrangement of game pieces, and where these subset of tiles are reversed within the entire sequenced arrangement to provide a rearranged sequence of electronic game pieces, known as the Round Ending Order 210. Note that although the figures described herein generally show sequences of letters, each letter may be presented as a separate game piece tile in an embodiment of the game. Such detail representation is not included here for clarity of the figures.

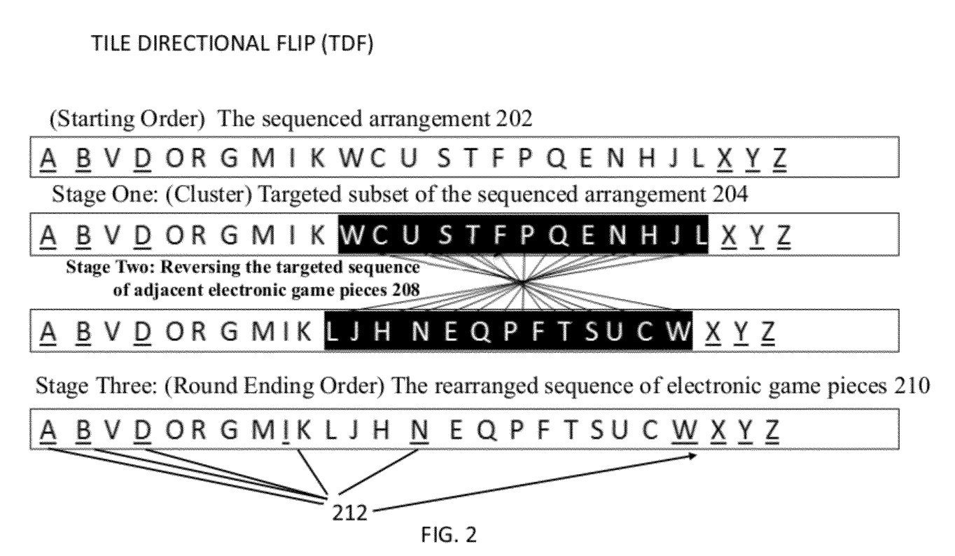

Referring to FIG. 2, which depicts a sequence of actions performed during a Round to perform a Tile Directional Flip, each TDF of Game Pieces occurs in three stages. In Stage One, the player starts a TDF by viewing the Final Order 104 and the current Round starting order 202. The player determines which game pieces are in the expected position of the Final Order 104 and considers how to manipulate the game pieces in this Round so that all of the pieces are in the Final Order 104 sequence, if possible, or the end result of the TDF progresses the order to reach this objective. In Stage Two, the player determines which range, the subset of the sequenced arrangement of game pieces, (also defined as a “Cluster”) should be used to progress the order from the starting order 202 toward the final order 104 TDF. The player selects a first electronic game piece, a second electronic game piece, and all game pieces positioned between the first and second selected pieces. In FIG. 2 Stage Two, the player has selected a Cluster 204 starting with the tile W through the tile L. In Stage Three, the player does the TDF 208 that reverses the order of the game pieces in the Cluster. The result is a new arrangement of electronic game pieces, also known as the Round Ending Order 210, which will become the Starting Order for the next Round's TDF. After Stage 3 and before the start of the next Round, the game pieces are compared to the Final Order 104 of game pieces to see if any of them are in the proper position defined by the Final Order 104. Each such piece is considered to be in its Ordered Place 212.

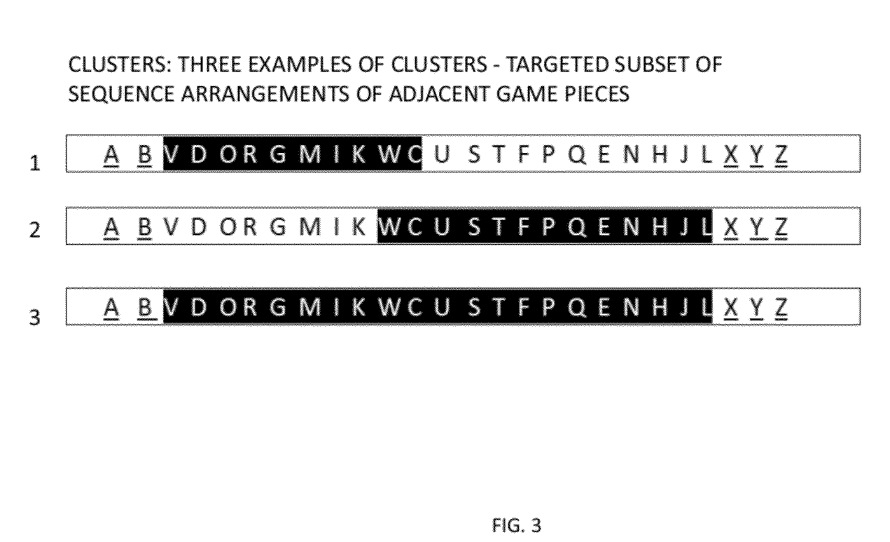

Referring to FIG. 3, which depicts three examples of Clusters. Generally, Clusters occur between Ordered Place game pieces. However Clusters can include Ordered Place game pieces.

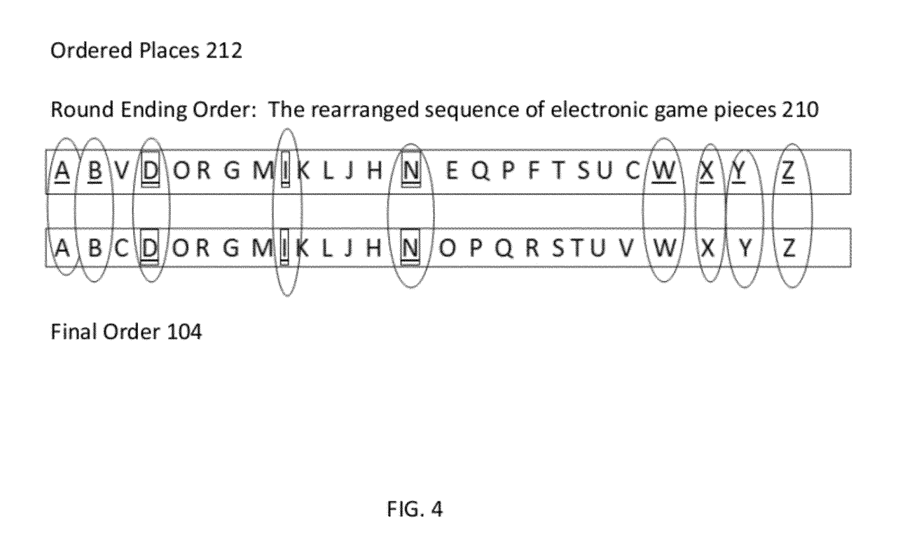

As FIG. 4 showcases, the game pieces A, B, D, I, N, X, Y and Z are Ordered Place game pieces 212 because each is positioned in the position defined by the Final Order 104. In the Round Ending Order 210 depicted in FIG. 4, each Ordered Place game piece 212 is indicated by an underline of the game piece letter. The tiles in the round ending order 210 that match the position in the final order 104 are also identified by an oval that encompasses the Ordered Place game pieces in each order. Note, if the position of all of the tiles in a Round Ending Order 210 match the tile position in the final order 104, the game is completed by the player. If not, the player may start the next Round.

A first type of game includes Final Order Games (referred herein as “FOG”) where the player's end objective is to rearrange the game pieces into the final target sequenced arrangement or Final Order 104. The player strives to reach the Final Order 104 from an initial starting order 102 of sequenced arrangement of game pieces by completing one or more rounds (and TDFs). Both game scoring and selecting who wins may be based on a number of factors depending on the game rule set being used, including number of TDFs, number of tiles displaced during TDFs, number of ordered places, number of ordered place game pieces included in clusters, time from start to finish to accomplish the steps of play to get an initial starting order 102 sequenced arrangement of game pieces into a Final Order 104, and the like.

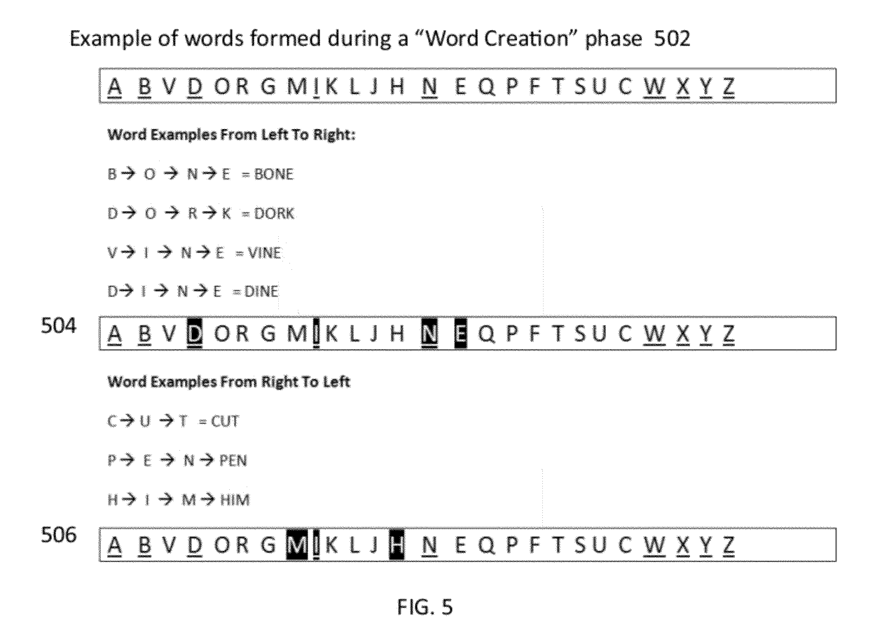

A second type of game includes Final Order Games With Words (referred herein as “FOGWW”) where the player strives to reach the Final Order 104 of a sequenced arrangement of game pieces, similar to FOG, and for each round, a player after performing a TDF (e.g. Between Rounds), may seek to find words from the newly arranged sequence of tiles and where each identified word may score points. Known as the Word Creation Phase, which is depicted in FIG. 5, the player forms as many words as possible either during a defined time period or without any time period. In FIG. 5, the player, after the TDF, views the newly rearranged tiles of the round ending order 502 to see which tiles are newly in Ordered Places, as signified by a rectangle encasing the letters “D”, “I” and “N.” Next, the player uses the entire sequenced arrangement of tiles, (e.g. From “A” to “Z” in FIG. 5), to create words. Words may be formed from left to right, or right to left, and words do not need to be created from adjacent letters. The word “DINE” 504 contains these 4 letters ordered from left to right, and skips over many tiles. The word “HIM” 506 contains these 3 letters ordered from right to left, and also skips over many tiles. Once the player has exhausted efforts to find and identify words (or the time limit for the Word Creation Phase expires), the player may start a new round where the Ending Order becomes the new Starting Order, and executes a TDF. Each Round may include this Word Creation Phase after the TDF and Rounds are repeated until the Final Order is reached. In addition, the player may either be rewarded or penalized points based on the number of rounds undertaken to complete the game. The player may receive points for each tile used in each word formed, based on a combination of factors. In multi-player competitions, the player with the most points after completing the game may be declared the winner of the competition as all players start with the same sequence arrangement of game pieces. Other variations of FOGWW, including other ways of competing and determining a winner or winners are possible and are contemplated herein.

Each type of game could be played using a school-like workbook for a book presentation, or as a traditional physical board game with physical game pieces, but embodiments of the game may best suited for electronic game play including electronic game pieces, digital implementation, and mass-person competitions in which all competitors start with the same sequenced arrangement of game pieces as an initial Starting Order 102 and all with a same Final Order to achieve. Competitions may include handicapping, competition tiers, timed and untimed variants, location related challenges, and the like.

Both FOG and FOGWW games, as describe herein, can also deviate within the game in a number of ways, based on rules presented, where players may have to conduct TDFs to reach new targeted sequence arrangements that are not the Final Order, and once conditions are met, the player then can conduct new Rounds to reach the Final Order.

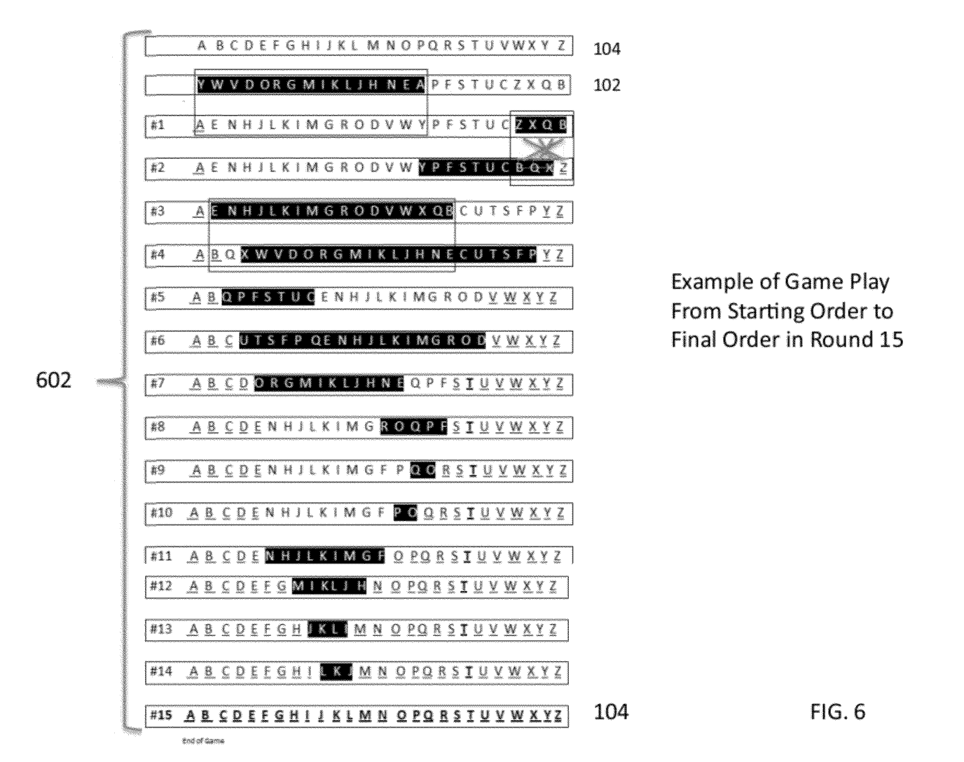

Referring to FIG. 6, a category of games occurs where all the sequenced arrangement of game pieces are included in this game in the initial Starting Order and must be flipped, e.g. Rearranged into the Final Order. The game is a series of Rounds required to play the FOG game as the player works to rearrange the game pieces from the initial Starting Order to Final Order. The Final Order can be a targeted sequence arrangement consisting of a series of words, or a series of images, or a series of alphanumeric characters, or a series of mathematical symbols, or a series of symbols, or in the form of a slogan in an electronic advertisement. As FIG. 6 illustrates, for the player at the initial Starting Order, preparing for his or her first round's TDF, one challenge is that there is a nearly unlimited number of potential ways to complete the game based not only on putting the game pieces in the right order in the least number of TDF moves, but also factoring in the number of game pieces that are already in their Ordered Places 212, the total count of clustered game pieces across all Rounds, and the time it takes to make these TDFs.

In FIG. 6, we illustrate one such series of TDF rounds 602 from initial starting order 102 to final order 104. One technique a player may use for reaching the Final Order is to secure Ordered Place game pieces at either or both ends of the sequenced arrangement and working, over multiple Rounds, increasingly towards the middle. In a first Round that results in the row labeled #1, the Cluster identified within the initial starting order 102 starts with the Letter “Y” and includes all tiles up until the letter “A”. The Round Ending Order after the TDF places the “A” in its Ordered Place 212, at the far left side. In a second Round that results in the row labeled #2, the player reviews Round 1's Ending Order and identifies a Cluster from “Z” to “B”, (the shaded Z, X, Q, B) and executes the TDF to place the “Z” in its Ordered Place as depicted in Round #2's Ending Order. In Rounds #3 to #6, this strategy is highlighted by the shaded Clusters in the prior Round that lead to A, B, C and V, W, X, Y in ordered places as depicted in Round #6's Ending Order. The game continues in Rounds until the Final Order is achieved in Round #15.

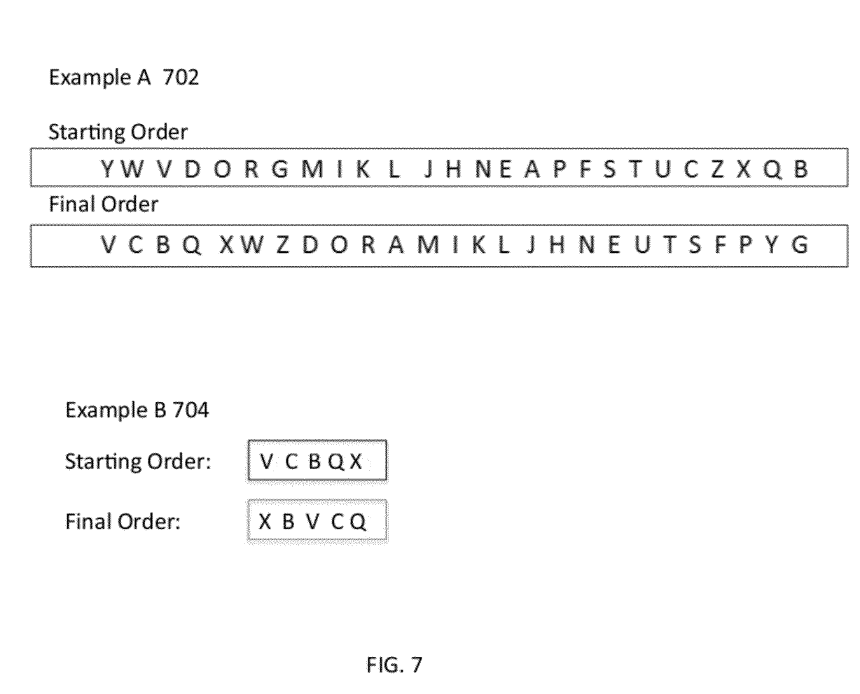

Referring to FIG. 7, another way to play is to have any number of game pieces, from 1 to N, as long as there are the same game pieces in both the initial Starting Order 102 and Final Order 104. Example A uses 26 tiles, whereas Example B only uses 5 tiles.

Another way to play is to have a game that may include any order of the alphabet's 26 game pieces (A-Z) as an initial Starting Order 102, without any duplicates, and that may include any order of the same 26 game pieces ending as a Final Order 104 as shown in FIG. 1. In this example, the Final Order is in the alphabetical order of letters A to Z. If FOGWW, the time period during the Word Creation Phase of each round can have a finite time within a Round, or have a cumulative time limit in multiple rounds, or not be timed at all.

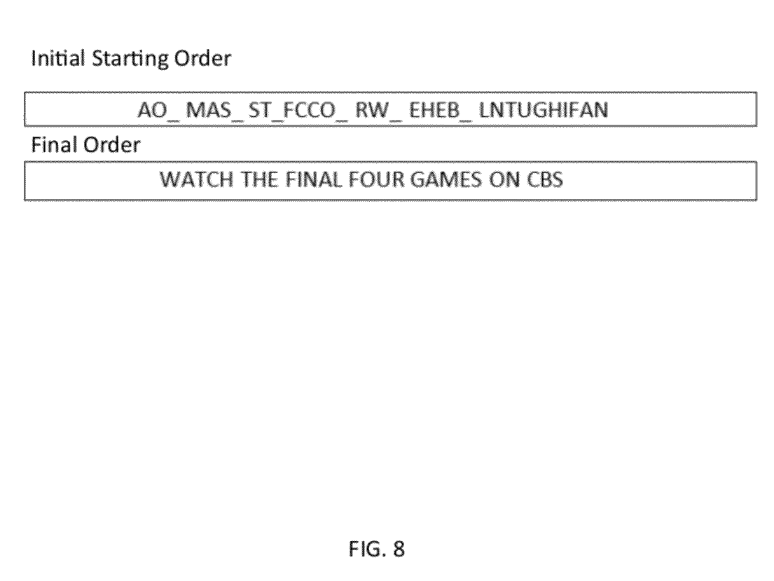

Referring to FIG. 8, another way to play is when a Final Order 104 consists of the same game pieces of the initial Starting Order 104, but form a series of words. This game may also contain blanks (spaces), to create these words, as part of the Final Order. If FOGWW, the time period during the Word Creation Phase of each round can have a finite time within a Round, or have a cumulative time limit in multiple rounds, or not be timed at all.

Another way to play is to not provide the Final Order to the player at the game start and, when may be appropriate, insert clues to the player for the player to guess the Final Order. In this game, the player is provided the initial Starting Order, and then as the game progresses, the player may be shown additional game pieces in their Ordered Places 212 after each TDF, and, at appropriate times during the game, the player may also receive written hints if the Final Order is a series of words or part of an electronic advertisement. Hints may be generated when a certain number of Ordered Places 212 are achieved, or on certain Rounds.

Another way to play is where the sequenced arrangement of game pieces can be either capital letters or lower-cased letters, as depicted at the initial Starting Order 102 and also in the Final Order 104. In other words, a “B” and “b” in the word “Baseball” would need to have the “B” and “b” respectively in the right Ordered Places 212, and not “b” and “B” (as in “baseball”) in order to match the Final Order 104 and to complete the game.

For FOGWW only, another way to play is to have any order of game pieces, from 1 to X number, as the initial Starting Order 102, with tile duplicates allowed in the Word Creation Phase. For example, the player can create a word, such as Baseball by only having one “L” as part of the tiles within the sequence of arranged game pieces.

For FOGWW only, another way to play is to have the game make the TDFs for each Round of the game. The player only has to form words from the resulting Ending Order's sequence of game pieces after each TDF. The game ends when a Final Order, consisting of the same game pieces, is reached. Word results (cumulative points scored in each round) may be compared against a number of criteria, including the maximum potential words that could be created using a dictionary, or against another player, or against unlimited number of multiple players. The time period during the Word Creation Stage of each round can have a finite time within a Round, or have a cumulative time limit in multiple rounds, or not be timed at all.

Another way to play is to substitute mathematical numbers and symbols, images, colors, and/or symbols (or any combination of) as game pieces rather than only use alphanumeric characters for all game pieces, for creating the initial Starting Orders of tiles and Final Orders of a game as seen in FIG. 9. One variation of this game could, for example, be the opportunity to “lock in” the operators (+−x/=) and allow the player to only do a TDF using the numbers. It is possible that new embodiments to play, not described herein, will be developed based on using a combination of these non-alphanumeric math symbols, symbols, images and/or colors, with alphanumeric characters.

Another way to play is to include the color of the Tile as part of the game piece, along with alphanumeric characters (a Red letter “W” for example), and also add colors to images mathematical symbols or symbols that can be viewed on the tile. For example, tiles with images, with or without color, may be used in any of the games described herein, and may be expressly targeted to young children to improve their spelling, vocabulary, and language/brain/hand coordination and learning.

Another category of games occurs where the Final Order DOES NOT have to have every game piece in its Final Order, but all the tiles need to be in the Final Order that was in the initial Starting Order. The Final Order can have a subset of specified tiles in their Ordered Places and other tiles that can be in any place within the target arrangement of sequenced game pieces. This state of the game occurs in a number of variations, as described below. In all cases, there are certain “Ordered Places” that need to be matched at the Final Order completion of the game, but where there is not this “ordered place” requirement, and then any tile may be used. In a simple example, if the Final Order of a five tile game (Starting Order of RTFAB) is F@R@T, then the game is completed when the player has manipulated his or her TDF's where the F, R, and T are in their Ordered Places, but the A and B are viewed as “Free Agents” and can be in either tile location, as depicted by the @ symbol. The following examples provide different ways, but not all encompassing, in which to have Final Orders that provide challenge and strategy to occur for the player during the Rounds in the game play.

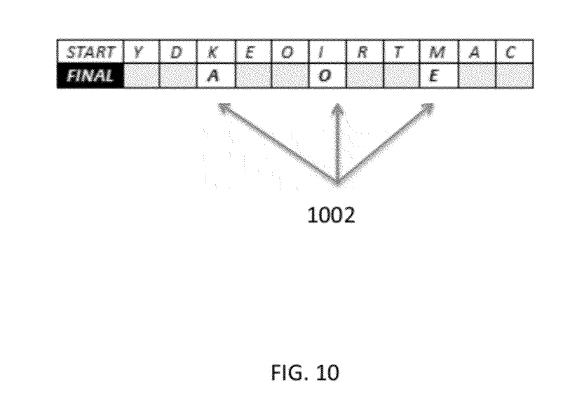

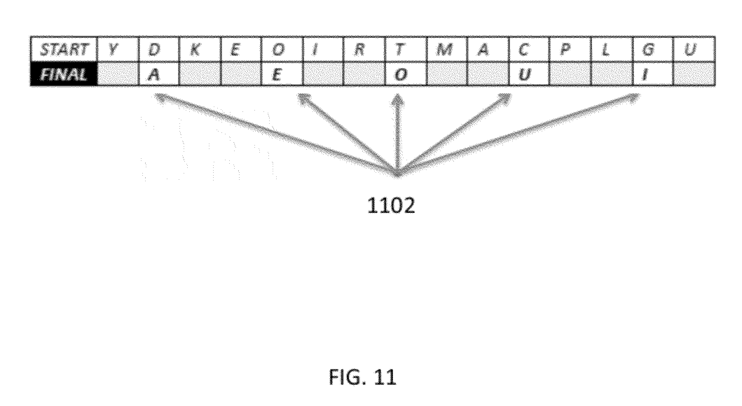

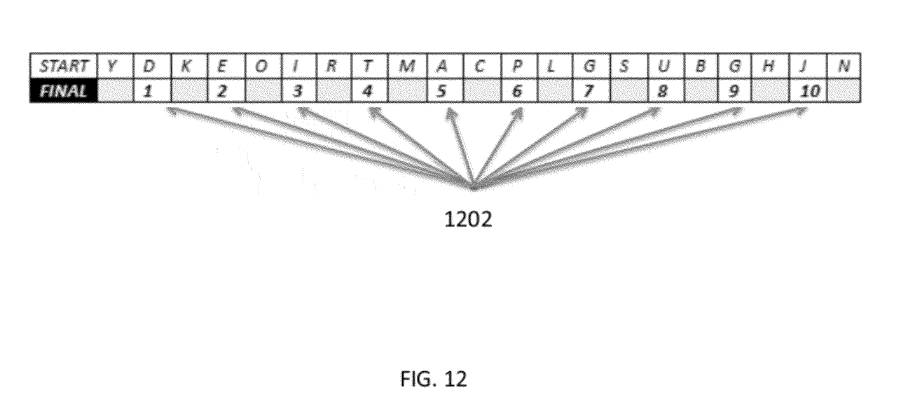

A way to play is to create an electronic playing board that has a set number of game pieces (1 to X number) in the initial Starting Order 102, and an equal number in the Final Order, where the Final Order contains certain Tiles that need to be in their right Ordered Place, and all other game pieces are “Free Agents”. One goal of the game may be to get the game pieces for these Ordered Places in their respective places in as few Rounds as possible and in as short amount of time as possible. In FIG. 10, this game example depicts 11 game pieces, where only 3 specified vowels 1002 (or any alphanumeric character, image, color, mathematical symbol or symbol) need to be in their Ordered Places in a Final Order. The other 8 game pieces can be in any other arranged places. Examples of two other configurations, of many examples, for this type of game are seen in FIG. 11 with 15 initial Starting Order game pieces, where only 5 vowels 1102 (A, E, I, O, U) have Ordered Places in the Final Order, and FIG. 12 where there are 21 initial Starting Order game pieces, and the player has to manipulate 10 of the 21 game pieces into their 10 Ordered Places 1202 in the Final Order. There exists numerous ways where the player may be presented with a Final Order involving one or more Ordered Places as a Final Order.

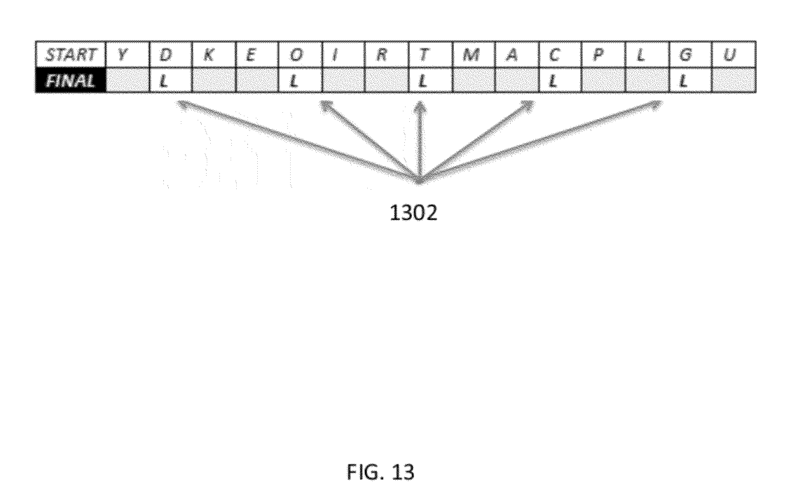

Another way to play is to expand on the previous games involving FIG. 10, 11, 12, but not to require the exact game pieces to be in their Ordered Places within the Final Order, but have the requirement that any tile, designated as a Final Order tile may appear in any of the designated Final Order places as viewed in FIG. 13. In other words, if the letters “A”, “B”, “C”, “D” and “E” were the five designated game pieces, they can be placed in any of the 5 Ordered Places 1302 of the Final Order.

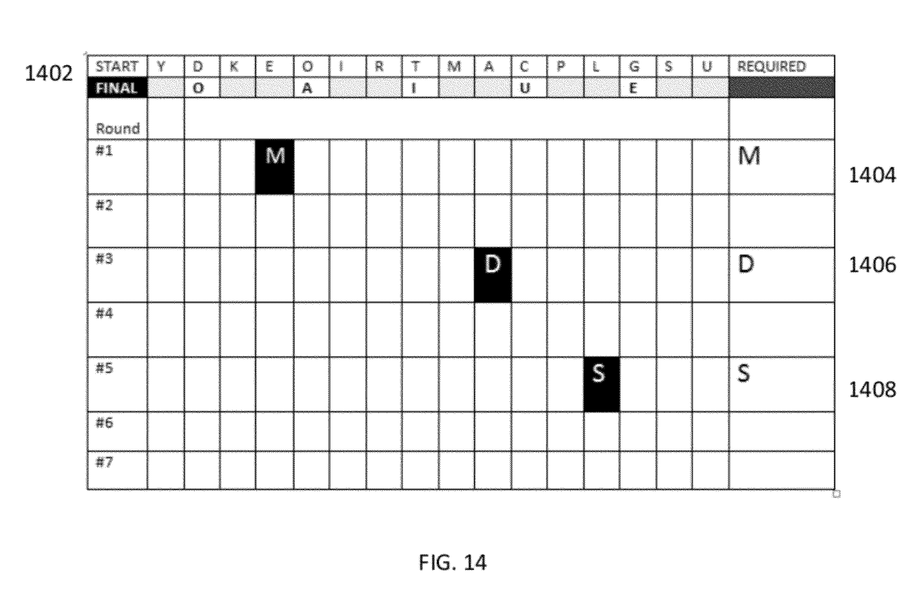

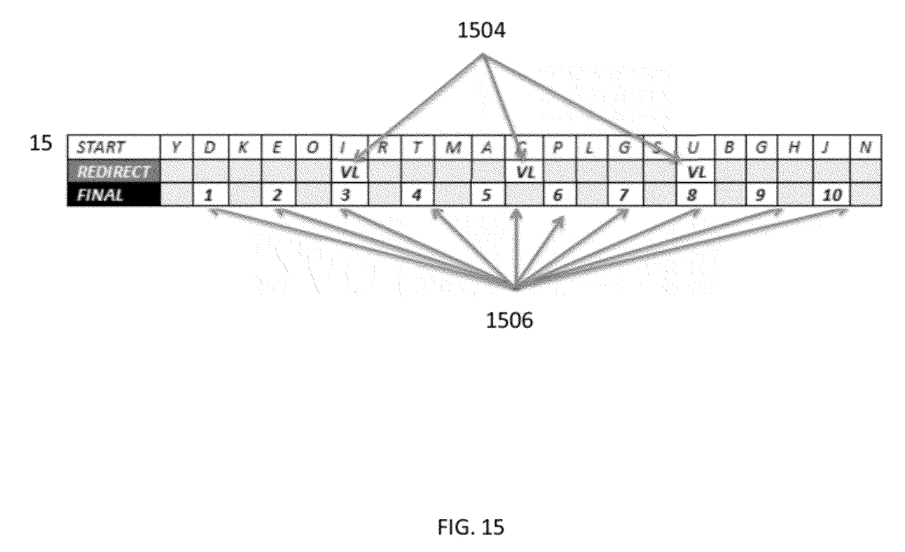

Another way to play is FIG. 14 where there are game pieces in an initial Starting Order 1402 and where certain game pieces need to be in their Ordered Places at intermediary steps in the game and these conditions need to be met either during certain Rounds of the game, or in a designated order, before the player can proceed to complete the Final Order. For example, in FIG. 14, prior to the first TDF, the player has the intermediate task at a specific Round to have a certain tile in its Ordered Place. For this game example, Round 1, 3 and 5 require the respective game pieces “M, D, and S” to be at their designated temporary Ordered Places at the end of these specified Rounds. After these requirements are met, the player proceeds in the new Round to conduct TDFs to reach the Final Order. Alternatively, the sequential order of first matching “M” in its Ordered Place 1404, then “D” 1406 and then “S” 1408 must occur in a variation of the same game in order for the player to proceed to solve the Final Order and complete the game. In another variation, the player must first have all the game pieces (“M, D and S”) in their Ordered Places, similar to FIG. 10, before proceeding. For this type of game with intermediate conditions to be met, competition between players (competing alone, yet against each other) could also involve points for reaching the specified game pieces first, in a time-based race, similar to a runner racing around a quarter-mile track four times and being rewarding, e.g. Scoring points, for being the first to reach the end of each lap. The player who first reaches these Ordered Place game pieces or the defined targeted subset of sequence arrangements may receive additional benefits, depending on how the game is structured. In FIG. 15, another example is depicted of a potential configuration of an initial Starting Order 1502, and certain intermediary sequences of arranged game pieces that must be met 1504 before solving for the specific Final Order 1506.

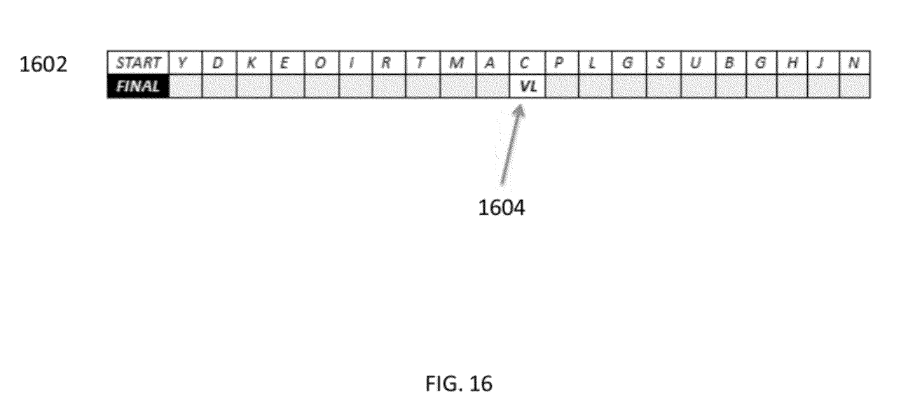

For FOGWW only, another way to play is FIG. 16 where there are game pieces in an initial Starting Order 1602, and there is only one Ordered Place 1604 to reach for one designated tile, and the player does a TDF and then finds the most words possible.

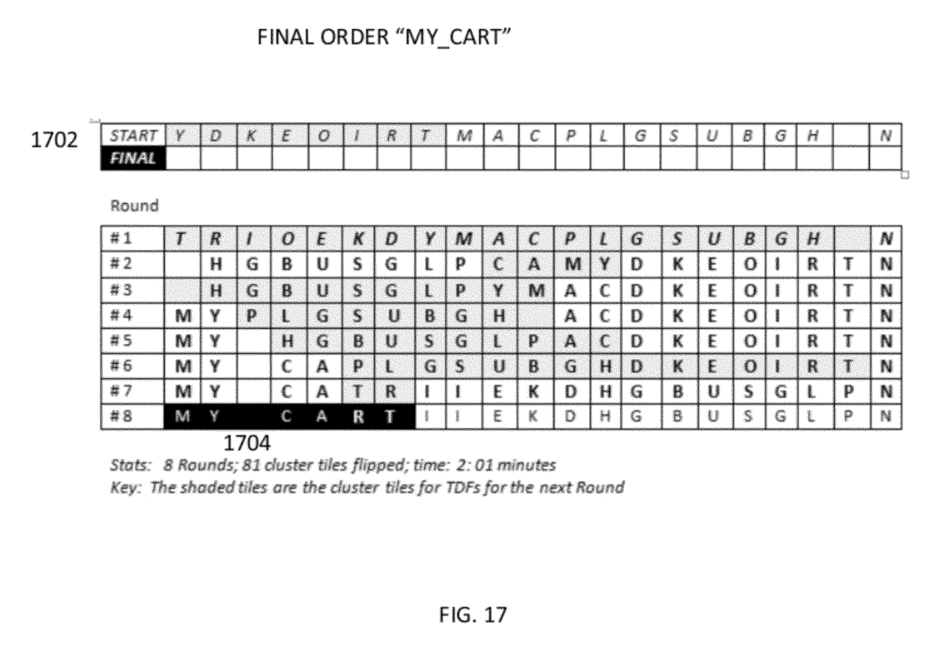

Another category of games occurs where the Final Order can be a subset of the sequenced arrangement of game pieces that are in the initial Starting Order, and not all tiles need to be accounted for in the Final Order, only the target sequenced arrangement of game pieces identified as the Final Order. In other words, the Final Order, may be only a subset of specified tiles of the initial Stating Order, and does not have specified Ordered Places within the entire sequenced arrangement (of the initial Starting Order 1702.) This state of the game occurs where the Final Order, usually as a series of words (although it could include mathematical symbols, images, colors and/or symbols or any combination of), does not consist of all the game pieces displayed. This would allow the player to choose where, within the targeted sequence arrangement of game pieces, to align the right tiles into the appropriate Final Order. There could be any number of game pieces creating the initial Starting Order 1702, and any number of game pieces for the subset sequence of game pieces as the Final Order. Referring to FIG. 17, the Final Order phrase to achieve is “My Cart” 1704 and the player has 21 game pieces to use and through TDFs, the player has to arrive at that Final Order 1704, somewhere within the 21 tile sequenced arrangement. In this game example, it took 8 Rounds, with 81 game pieces being flipped as Clusters, and the TDFs were done in a specific time frame. Note, there may be many other ways to play this same game to arrive at “MY CART” as the Final Order and have the first tile “M” be placed in a different starting place within the sequenced arrangement.

Another way to play in this state of the game, where the Final Order can be a subset of the Starting Order's sequence of game pieces as described above, and using FIG. 17, as the example, is to allow the player the opportunity to remove a tile after each TDF from the set of game pieces being played. The player, in FIG. 17, after Round 1, and before Round 2, would specify one of the game pieces to be removed, say the E, and the E would disappear from the game. After each Round the player would have the option of removing a tile. The objective would be to complete the last TDF that gets to the Final Order where there are no excess game pieces in the tile set. For scoring purposes, penalty points may be assessed, based on the rule set used, for extra game pieces left after the Final Order (the subset of initial sequenced arrangement of game pieces) is achieved.

Another category of games occurs where the Final Order does not have to have every game piece in the initial Starting Order to be in its Final Order, but where certain game pieces need to first be in a new targeted sequenced arrangement, “Phase”, that is different from the Final Order. The player cannot attempt to conduct TDFs to attain the Final Order's subset of game pieces until the player reaches this Phase, the new target sequenced arrangement. Games may have one or more of these Phases that are separate and distinct from the Final Order, where each new target sequenced arrangement is different from the previous target sequenced arrangement, before the player can proceed to conduct more TDFs to complete the Final Order.

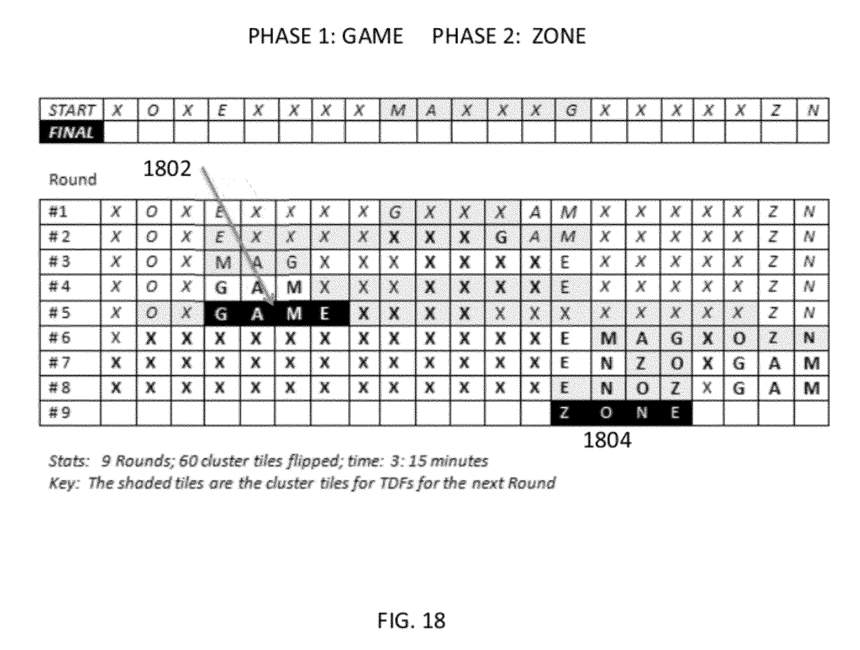

There could be any number of game pieces creating the initial Starting Order, and any number of game pieces for the phases, and any number of phases before the Final Order is to be completed. In FIG. 18, the game depicts two phases. Phase One is to find the target sequenced arrangement that forms the word “GAME” 1802 and Phase Two is to then conduct new TDFs to rearrange tiles to independently form the word “ZONE.” 1804. In other words, once the word “GAME” 1802 is reached, the player uses the next Rounds to rearrange game pieces to achieve the word “ZONE” 1804 without any reliance on the previous game pieces used to achieve “GAME” 1802. In this game example, it took 9 TDFs, with 60 game pieces being flipped, and these 9 Rounds were done in a specific time frame. Note, there could be many other ways to play this same game to arrive at completing each phase. The game pieces, in this example, that were not needed for either phase were intentionally given the letter “X” as they were not needed for completing either phase's targeted sequence of game pieces.

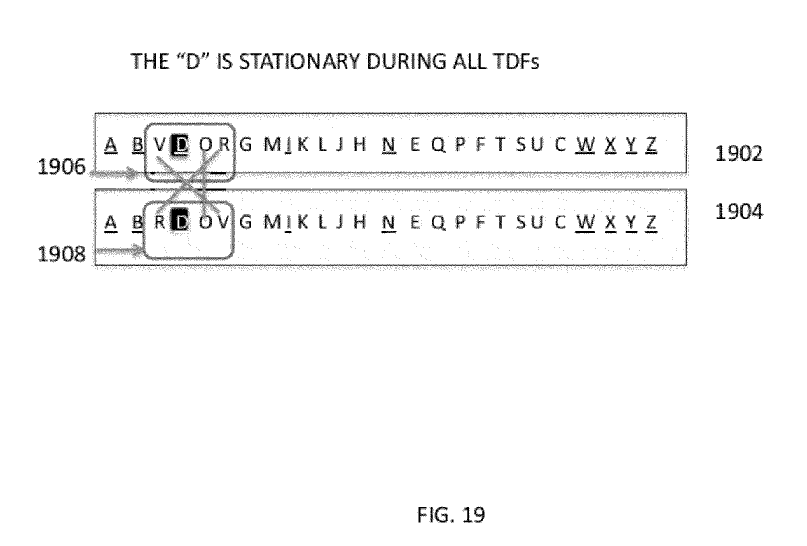

As referred in FIG. 19, another category of games occurs where the player is presented an initial Starting Order 1902 and a Final Order 1904, and after each round (and TDF), tiles become “locked in”, cannot be moved during any TDF, for all subsequent rounds. These game pieces are locked when a tile in a Round's Ending Order is in an Ordered Place of the Final Order. In subsequent rounds, the player has to conduct TDFs to reach the Final Order where each rearrangement of the subset of sequenced Game Pieces ignores these locked game pieces. In other words, the game pieces that are reversed during a TDF ignore the locked game pieces, if any. In the example in FIG. 19, the “D” is fixed in its Ordered Place, as shown by the underline of “D”, and the identified cluster to flip 1906 is “VDOR” and the rearrangement of the TDF game pieces occurs and does not include the “D” as the Round's Ending Order is “RDOV” 1908 where the VOR is reversed as ROV. This feature can be incorporated into almost any type of game described and does not impact the player's goal to attain the desired Final Order.

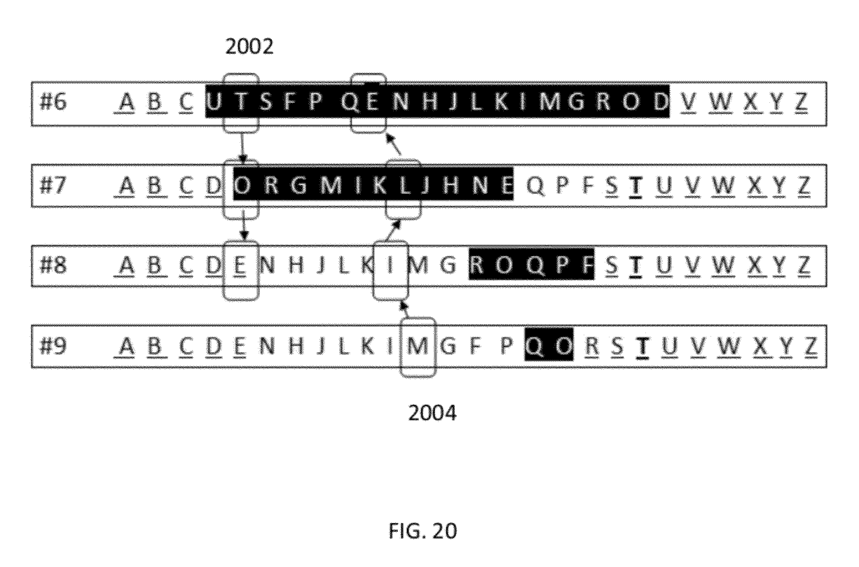

Another way to play is to keep all Rounds visible in a FOGWW type of game (the multiple rows of completed Rounds) as shown in FIG. 20, where the Round Ending Orders are viewable on a graphical user display or physical game board, and the player may score points by combining tiles on different rows using tiles in up/down or diagonal directions, to create words, as long as the Tiles are adjacent to each other either (left or right on the same row, up or down on separate rows, or diagonal on separate rows). The word may originate from any Round's row or from the last Round's Ending Order created, depending on the rules of play. In FIG. 20, the player identified the words “TOE” 2002 and “MILE.” 2004

Another category of games not contingent on the number of game pieces used in the initial Starting Order and Final Order is where one player, Player #1, competes directly against another player (or computer) as Player #2, and they play together on the same game board and game pieces, but can view the game from different graphical user displays, e.g. From difference computers. In FIG. 6, in this embodiment of a game, both players may play alternative Rounds. Player 1 would be responsible for TDF's #1, #3, #5 and all subsequent “odd number” Rounds whereas Player 2 would make TDFs in Rounds #2, #4, #6 and all “even number” ones. The associated rules and points may be different, too, for both FOG and FOGWW games, and if the players are teammates or opponents.

Another way to play between two players is to play as described directly above using the same electronic game board, and “locked” tiles, similar to FIG. 19, when an Ordered Place is reached as part of the previous player's Round's Ending Order. In this game, one player as Player #1 competes directly against another player (or computer) as Player #2 and they alternate Rounds. Each player completes a TDF and the game pieces, after this TDF, that are rearranged into their Ordered Places, are clearly marked as frozen in place, e.g. Locked in, and are no longer available for future TDFs. Similar to FIG. 19, the “non-locked” game pieces available for the TDF will reverse during a TDF and will ignore the “locked” game pieces by treating them as invisible. This feature can be incorporated into almost any type of game described and does not impact the goal to attain the desired Final Order.

Another way to play is for a player to play against another player using the same electronic game board, usually on different computers, and to have each player select an equal number of individual game pieces, which become their game pieces to arrange into the appropriate Ordered Places of the Final Order of the game. After each TDF by either player, game pieces are locked-in place that match the game's Final Order. The first player to “lock-in” all of their Final Order subset of game pieces is the winner.

Another way to play is to have more than one player being on the same team and playing the same game against another opponent or team, or against their own collected mutually-played game scores. These same-side players may alternate their rounds of the game.

Both FOG and FOGWW games, as described herein, may be played solo by a player where the player may only be concerned with how he or she plays to reach a final score. The player can improve his or her scores and performances, based on key metrics such as time to complete the game, number of TDFs, number of ordered places and number of game pieces used in Clusters. The player can also participate in multiplayer competitions where a player independently plays the game, and all player scores may be compared with each other to create leadership boards and winning players based on the rule set, same initial Starting Order, same game pieces and objectives being used.

Also, there are new games to be developed from the various games as described herein, where different embodiments of the game can be developed with rule sets for not only one player games, but also where more than one player can play within a game either on the same team or competing against another player or players in multiplayer competitions. Also, for most type of games, the initial Starting Orders and Final Orders are mostly pre-determined by the game itself before a player begins, although it would be possible for a player, in any of the game variations described herein, to have the ability to select both the game pieces, as well as the sequenced arrangements for both the initial Starting Order and the Final Order of a specific game to share with and challenge friends or others to play. In addition, in most cases, each game variation can be completed as a Final Order Game (FOG), by and of itself, and, unless otherwise stated, the rule set of the game could include adding the element of scoring points during an added Word Creation Phase FIG. 5 after each TDF, e.g. To turn the FOG game into Final Order Game With Words (FOGWW). There may also be new games that only work within the FOGWW framework.

In FOG games, player's score may differ for each game, depending on which variables are most important. In almost all cases, the least number of flips to accomplish the objectives in a game may be the most important aspect. Competition between another person or more than one person, or mass-competitions using the same initial Starting Order and Final Order can use the following variables: 1) # of Rounds; 2) The time (minutes, seconds, and fractional seconds) it takes the player from starting the game to completing the game; 3) The number of tiles in their Ordered Places, cumulative for all rounds. Conceivably, in one embodiment of the game, the player with the same number of TDFs and more Ordered Places should score more points than someone with less Ordered Place game pieces; and 4) The cumulative number of Cluster game pieces, added up after each TDF. Conceivably, in another embodiment of the game, the player with the same number of TDFs as the other player, and the same number of Ordered Places, and who used less Cluster Tiles should score more points than someone with more Tiles used, with everything else being equal. Depending on the game, the rule set will clearly define which variables are more important than other variables and will receive higher scores, especially for tie-breakers where more than one player has completed the game in the same number of Rounds.

In FOGWW Games, a player's score may be determined by adding together all points received in individual Rounds, plus all bonus points and then possibly subtracting all penalty points accumulated throughout the game, based on options for each word, play, and scoring bonus options within each Word Creation Phase. A Round's word score may also be determined by a magnification of points for each Round, either randomly applied, or by decreasing amounts or by increasing amounts as the rounds progress. For example, Round 1 may be 1.5× and Round 2 and Round 3 may be 1.3× and 1.7× respectively if these magnification rates are randomly applied.

In FOGWW, the player may receive points for each word and scaled points for the number of tiles in a word. The player also receive points for each tile used in each word formed, based on a combination of factors: 1) For a word that starts with a tile in its Ordered Place; 2) For a word that starts with a tile that is not in its Ordered Place; 3) For a word that includes a tile in its Ordered Place within the word, but not starting the word; 4) For a word that starts with a tile in its Ordered Place and also includes a tile in its Ordered Place that is not the first tile in the word; 5) For words with a minimum set number of game pieces in it as a bonus; 6) For words where a player uses a tile twice in a row, such as the R in Barred or the T in Mutter.

The player may also receive bonus points or penalty points during the game in the following potential ways: 1) Bonus points or penalty points for total number of rounds based on the number of game pieces being played in the game; 2) Potential bonus points or penalty points for words formed from left to right; or right to left. Also, potential exists for the game to end when a set point score has been reached before the Final Order has been achieved (all Tiles in their Ordered Places), or a set number of moves have been played.

Both FOG and FOGWW games can be played on a variety of distribution platforms as follows: Mobile platforms Apps (smart phones, IPAD™, IPHONE™, tablets); Web (browser game, stand alone program, client); Web—in ad units; FACEBOOK™ app; TWITTER™ app; GOOGLE™ app; Other social media apps (PINTEREST™, PATH™, INSTAGRAM™, and the like); Consoles (XBOX™, PLAYSTATIONT™, WII™ PSP, NINTENDO™ DS, and the like); Smart TV apps; and as a physical board game.

The methods and systems described herein may be deployed in part or in whole through a machine that executes computer software, program codes, and/or instructions on a processor. The present invention may be implemented as a method on the machine, as a system or apparatus as part of or in relation to the machine, or as a computer program product embodied in a computer readable medium executing on one or more of the machines. The processor may be part of a server, client, network infrastructure, mobile computing platform, stationary computing platform, or other computing platform. A processor may be any kind of computational or processing device capable of executing program instructions, codes, binary instructions and the like. The processor may be or include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more thread. The thread may spawn other threads that may have assigned priorities associated with them; the processor may execute these threads based on priority or any other order based on instructions provided in the program code. The processor may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In embodiments, the process may be a dual core processor, quad core processors, other chip-level multiprocessor and the like that combine two or more independent cores (called a die).

The methods and systems described herein may be deployed in part or in whole through a machine that executes computer software on a server, client, firewall, gateway, hub, router, or other such computer and/or networking hardware. The software program may be associated with a server that may include a file server, print server, domain server, internet server, intranet server and other variants such as secondary server, host server, distributed server and the like. The server may include one or more of memories, processors, computer readable media, storage media, ports (physical and virtual), communication devices, and interfaces capable of accessing other servers, clients, machines, and devices through a wired or a wireless medium, and the like. The methods, programs or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the invention. In addition, all the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The software program may be associated with a client that may include a file client, print client, domain client, internet client, intranet client and other variants such as secondary client, host client, distributed client and the like. The client may include one or more of memories, processors, computer readable media, storage media, ports (physical and virtual), communication devices, and interfaces capable of accessing other clients, servers, machines, and devices through a wired or a wireless medium, and the like. The methods, programs or codes as described herein and elsewhere may be executed by the client. In addition, other devices required for execution of methods as described in this application may be considered as a part of the infrastructure associated with the client.

The client may provide an interface to other devices including, without limitation, servers, other clients, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the invention. In addition, all the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements.

The methods, program codes, and instructions described herein and elsewhere may be implemented on a cellular network having multiple cells. Example cellular networks may include frequency division multiple access (FDMA) networks, code division multiple access (CDMA) networks, and other as are known in the art. An exemplary cellular network may include mobile devices, cell sites, base stations, repeaters, antennas, towers, and the like. The cell network may be a GSM, GPRS, 3G, EVDO, mesh, or other networks types.

The methods, programs codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer to peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g. USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical and/or or intangible items from one state to another. The methods and systems described herein may also transform data representing physical and/or intangible items from one state to another.

The elements described and depicted herein, including in flow charts and block diagrams throughout the figures, imply logical boundaries between the elements. However, according to software or hardware engineering practices, the depicted elements and the functions thereof may be implemented on machines through computer executable media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipments, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps thereof, may be realized in hardware, software or any combination of hardware and software suitable for a particular application. The hardware may include a general purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

While the invention has been disclosed in connection with the preferred embodiments shown and described in detail, various modifications and improvements thereon will become readily apparent to those skilled in the art. Accordingly, the spirit and scope of the present invention is not to be limited by the foregoing examples, but is to be understood in the broadest sense allowable by law.

All documents referenced herein are hereby incorporated by reference.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. A method for a word game, the method comprising:
providing a plurality of electronic game pieces;
providing a first sequenced arrangement of said plurality of electronic game pieces;
identifying a target sequenced arrangement of the electronic game pieces;
enabling a player, as a step in play, to reverse the sequence of any subset of electronic game pieces within the sequenced arrangement to provide a rearranged sequence of electronic game pieces; and
prompting the user to repeat a number of such sequence-reversing steps until the electronic game pieces match the target sequenced arrangement.

23. The method according to claim 22, wherein an electronic game piece is a representation of an alphanumeric character.

24. The method according to claim 22, wherein an electronic game piece is a representation of an image.

25. The method according to claim 22, wherein the electronic game pieces are displayed electronically.

26. The method according to claim 22, wherein an electronic game piece is a representation of a color.

27. The method according to claim 22, wherein an electronic game piece is a representation of a symbol.

28. The method according to claim 22, wherein an electronic game piece is a representation of a mathematical symbol.

29. (canceled)

30. (canceled)

31. (canceled)

32. (canceled)

33. (canceled)

34. (canceled)

35. (canceled)

36. (canceled)

37. The method according to claim 22, wherein a player identifies a target sequenced arrangement.

38. The method according to claim 22, wherein the sequenced arrangement is comprised of a sequence of adjacent game pieces.

39. (canceled)

40. The method according to claim 22, wherein a player identifies a plurality of target sequenced arrangements.

41. (canceled)

42. A method for a word game, the method comprising:
providing a plurality of electronic game pieces;
providing a first sequenced arrangement of said plurality of electronic game pieces;
identifying a target sequenced arrangement of the electronic game pieces;
enabling a player, as a step in play, to reverse the sequence of any subset of electronic game pieces within the sequenced arrangement to provide a rearranged sequence of electronic game pieces; and
identifying a new target sequenced arrangement of the electronic game pieces.

43. The method according to claim 42, wherein an electronic game piece is a representation of an alphanumeric character.

44. The method according to claim 42, wherein an electronic game piece is a representation of an image.

45. The method according to claim 42, wherein an electronic game piece is a representation of a color.

46. The method according to claim 42, wherein an electronic game piece is a representation of a symbol.

47. The method according to claim 42, wherein an electronic game piece is a representation of a mathematical symbol.

48. The method according to claim 42, wherein the electronic game pieces are displayed electronically.

49. The method according to claim 42, wherein the electronic game pieces are displayed using a graphical user interface.

50. (canceled)

51. (canceled)

52. (canceled)

53. (canceled)

54. (canceled)

55. (canceled)

56. (canceled)

57. (canceled)

58. The method according to claim 42, wherein a player identifies a target sequenced arrangement.

59. (canceled)

60. (canceled)

61. (canceled)

62. (canceled)

63. (canceled)

64. (canceled)

65. (canceled)

66. (canceled)

67. (canceled)

68. A method for a word game, the method comprising:
providing a plurality of game pieces;
providing a first sequenced arrangement of said plurality of game pieces;
identifying a target sequenced arrangement of the game pieces;
enabling a player, as a step in play, to reverse the sequence of any subset of game pieces within the sequenced arrangement to provide a rearranged sequence of game pieces;
identifying a new target sequenced arrangement of the game pieces.

69-90. (canceled)
